(19) United States
(12) Patent Application Publication
(10) Pub. No.: US 2017/0138401 A1
(43) Pub. Date: May 18, 2017

(54) BEARING ELEMENT FOR A PLAIN OR ANTIFRICTION BEARING

(71) Applicant: Schaeffler Technologies AG & Co. KG, Herzogenaurach (DE)

(72) Inventors: Christian Schulte-Noelle, Bamberg (DE); Claus Mueller, Eckental (DE); Yegor Rudnik, Schweinfurt (DE)

(21) Appl. No.: 15/127,335

(22) PCT Filed: Mar. 3, 2015
(86) PCT No.: PCT/DE2015/200116

§ 371 Date: Sep. 19, 2016

(30) Foreign Application Priority Data
Mar. 20, 2014 (DE) 10 2014 205 164.9

(51) Int. Cl. F16C 33/62; F16C 33/56; F16C 33/44; F16C 33/12; F16C 33/14

(52) U.S. Cl. CPC F16C 33/62; F16C 33/121; F16C 33/14; F16C 33/44; F16C 33/56; F16C 2202/04; F16C 2206/40; F16C 2206/80; F16C 2220/20; F16C 2240/54; F16C 2300/42

(57) ABSTRACT

A bearing element (1) for a plain or antifriction bearing is provided, the bearing element (1) being formed of or including at least sectionally a powder-metallurgical composite material which includes a metallic binder phase and a hard material phase, wherein the metallic binder phase is based on at least one element from the following group: chromium, cobalt, molybdenum, nickel, titanium.

### FIELD OF THE INVENTION

The invention relates to a bearing element for a plain or antifriction bearing, said bearing element being formed of or comprising at least sectionally a powder-metallurgical composite material which comprises a metallic binder phase and a hard material phase.

### BACKGROUND

Bearing elements for plain or antifriction bearings, especially in the form of bearing rings, are widely known and are generally formed of materials with particularly high mechanical robustness, i.e., in particular, conventional antifriction bearing steels. For applications involving particular corrosive stresses, moreover, powder-metallurgical composite materials and also plastics materials and ceramic materials are known for the formation of such bearing elements.

Particularly in relation to the use of such bearing elements in operating situations without conventional lubrication, in other words primarily in corrosive (highly) fluid media, more particularly aqueous media, in which such bearing elements are deployed for long periods and by which the bearing elements are washed, there is a development requirement for materials with high robustness, both mechanically and in terms of corrosion, for the formation of such bearing elements. Operating situations of this kind, involving both high mechanical stress and high corrosive stress, particularly on account of an inability to realize effective lubrication of the bearing elements, exist in particular for applications in hydraulic structures, such as marine power stations, lock gates, or in saltwater or freshwater turbines, or in drillhead, compressor or pump bearings. In these applications, there is also a risk of cavitation.

### SUMMARY OF THE INVENTION

It is an object of the present invention to provide a bearing element which is highly robust, in particular both mechanically and corrosively.

The present invention provides a bearing element of the type specified at the outset, which is distinguished by the fact that the metallic binder phase is based on at least one element from the following group: chromium, cobalt, molybdenum, nickel, titanium.

Proposed in accordance with the invention is a bearing element for a plain or antifriction bearing, said bearing element being formed or produced at least sectionally from a powder-metallurgical composite material comprising a metallic binder phase and a hard material phase, or at least sectionally comprising a powder-metallurgical composite material of this kind. The particular feature of the bearing element of the invention lies especially in the (chemical) composition of the metallic binder phase.

The metallic binder phase is based in accordance with the invention on at least one element from the following group: chromium, cobalt, molybdenum, nickel, titanium. This means that the metallic binder phase is formed of at least one element from the following group: chromium, cobalt, molybdenum, nickel, titanium, or comprises as principal constituent at least one element from the following group: chromium, cobalt, molybdenum, nickel, titanium. This also means, however, that the metallic binding phase is formed of a metallic compound comprising chromium and/or cobalt and/or molybdenum and/or nickel and/or titanium or comprises at least one such compound. The stated elements may therefore be present in elemental form or in (chemically) bonded form.

The powder-metallurgical composite material is notable in general for a comparatively tough metallic binder phase and a comparatively hard hard material phase. The toughness of the metallic binder phase compensates the brittleness of the hard material phase and means that the composite material has sufficient (overall) impact strength. The hardness of the hard material phase gives the composite material high hardness. Both the metallic binder phase and the hard material phase are extremely corrosion-resistant. The powder-metallurgical composite material therefore has high strength, toughness, hardness, overrolling resistance, and wear resistance, especially with respect to abrasion, adhesion, and cavitation, and also high corrosion resistance. The same is true of the bearing element of the invention that is manufactured or produced from this material.

As a result of the comparatively high toughness of the composite material, it is also possible to realize relatively large bearing elements with high mechanical and corrosive robustness, in other words, in particular, relatively large bearing rings, these being bearing rings with a diameter of up to around 1000 mm. In relation to use in or as plain bearings or antifriction bearings, the toughness of the composite material also reduces the formation of cracks capable of propagation, resulting from the overrolling of foreign particles, and reduces the possibility for failure through high dynamic stressing.

Depending on the specific chemical and proportional composition of the composite material, it is possible in particular to realize bearing elements having the following physical and/or mechanical characteristics; density 5-15 g/cm³, compressive strength 2000-8000 MPa, elasticity modulus 400-700 GPa, hardness 1000-2000 HV. The numerical values given are purely exemplary and may as mentioned vary—i.e., may also be higher or lower, in particular—depending on the respective chemical and proportional composition of the composite material.

The particular chemical and proportional composition of the powder-metallurgical composite material is therefore the basis for the special profile of properties of the bearing element of the invention, predestining the bearing element, in particular even without conventional lubrication, for use in fields of application involving high mechanical and corrosive stresses. Corresponding fields of application may lie, for example, in corrosive environments, i.e., for example, in non-aqueous or aqueous, especially chlorine-containing, and also acidic or basic environments, as for example in the sector of tidal or marine power stations, i.e., in particular, offshore wind turbines, offshore conveyor systems, hydraulic constructions in general, or other marine applications, such as ships, for example, these being especially ship propulsions, or else in the sector of pumps and compressors. Dry-running applications or fields of application involving minimal lubrication as well are relevant, as in the food and drug industries, for example.

The bearing element of the invention and the composite material forming it are each produced by powder-metallurgical processes, these being processes based on a starting material or mixture of starting materials in powder form. The use of powder-metallurgical processes is especially advantageous since it allows the formation of microstructures having (virtually) isotropic properties. Generally speaking, as well, the use of powder-metallurgical processes allows near-net-shape manufacture or primary forming of the bearing element, thereby largely reducing the need for mechanical steps, i.e., more particularly, cutting steps of subsequent machining, and so being advantageous in manufacturing and hence also economic terms.

A powder-metallurgical process of this kind for producing the bearing element may be, for example, hot isostatic pressing, HIP for short; it may therefore be a powder-metallurgical manufacturing principle from the primary forming sector, whereby a starting material in powder form or mixture of starting materials in powder form is subjected under pressure and temperature to compaction and/or pressing and to sintering.

Another conceivable powder-metallurgical process for producing a bearing element of the invention is the spray compacting process, which is likewise a powder-metallurgical manufacturing principle from the sector of primary forming, whereby a starting material in powder form or mixture of starting materials in powder form is sprayed onto a support material and a component is “built up” on the support material by layer-by-layer application. An advantage of the spray compacting process over other powder-metallurgical processes is that here it is not necessary for complete compaction of the powder-form starting materials to take place. Another advantage of the spray compacting process is the possibility of realizing a “tailor-made” composition of the composite material, which may therefore be formed in accordance with locally and/or spatially distributed gradients of substance and/or of concentration.

Within the powder-metallurgical production of the composite material, it is conceivable for the material or mixture of materials in powder form, forming the metallic binder phase, to be combined with a material or mixture of materials in powder form that forms the hard material phase, within a powder-metallurgical process. As an alternative to this, it is conceivable first for the metallic binder phase to be produced by a powder-metallurgical process, and for the hard material phase to be formed in the metallic binder phase by the subsequent targeted formation of precipitations, for instance as part of the primary forming of the composite material, or of a heat treatment.

The metallic binder phase may further comprise fractions of iron and/or carbon and/or nitrogen and/or of at least one iron and/or carbon and/or nitrogen containing compound. In this way it is possible to exert a controlled influence over the spectrum of properties of the metallic binder phase with regard to a specific field of use of the bearing element of the invention. Equally it is possible in this way, if desired, to improve the connection between the metallic binder phase and the hard material phase, which is typically formed from individual hard material phase grains.

As mentioned earlier on above, the metallic binder phase may also be formed from a metallic compound containing chromium and/or molybdenum and/or nickel and/or cobalt and/or titanium, or may comprise at least one such compound. Accordingly, then, it is possible, for example, for the elements chromium, molybdenum, and titanium, where present, to be present in bonded form and therefore to be chemically bonded with further constituents of the metallic binder phase, such as iron and/or carbon and/or nitrogen, for example. It is conceivable, then, for example, for the metallic binder phase to comprise chromium carbide and/or molybdenum carbide and/or titanium carbide as carbon containing compound.

The hard substance phase associated with the powder-metallurgical composite material may be formed of at least one of the following hard substance compounds, or may comprise at least one of the following hard substance compounds: borides, carbides, more particularly titanium carbide and/or tungsten carbide, carbonitrides, more particularly titanium carbonitride, nitrides, more particularly titanium nitride, silicides. The hard substance phase may therefore be formed of or comprise, in particular, hard metals, i.e., in particular, sintered carbide hard metals, such as, for example, tungsten carbide, and/or cermets, i.e., ceramic particles present in a metallic matrix, based for example on nickel and/or molybdenum, examples being titanium carbide, titanium carbonitride or titanium nitride particles. Mixtures of (chemically) different hard substance compounds are of course conceivable.

The hard substance phase, moreover, may positively influence the thermal conductivity of the composite material, this being advantageous in particular with regard to the possibility of heat transport from the bearing element of the invention and therefore the capacity for cooling of the bearing element of the invention. This applies in particular to the use of hard substance compounds based on carbides, especially on tungsten carbides, the thermal conductivity of such compounds being greater by a multiple than that of unalloyed steels or stainless steels which are typically used in order to form conventional bearing elements.

As mentioned, the hard substance phase is typically formed of, or comprises, individual hard substance phase grains. The powder-metallurgical composite material may also comprise an intermediate phase, which is formed around the hard substance phase grains and via which attachment of the hard substance phase grains to the metallic binder phase is realized. For the example of hard substance phase grains formed of cermets, i.e., in particular, titanium carbonitride or titanium carbide, a κ phase, i.e., a complex carbide structure, has been shown, which wraps itself around the hard substance phase grains and ensures a firm attachment thereof to the metallic binding phase.

The volume fraction of the hard substance phase in the powder-metallurgical composite material is situated in particular in a range between 50 and 99 vol %, preferably in a range between 85 and 95 vol %. Correspondingly, the volume fraction of the metallic binding phase in the powder-metallurgical composite material is situated in particular in a range between 1 and 50 vol %, preferably in a range between 15 and 5 vol %. Care should be taken to ensure that the volume fraction of the hard substance phase does not fall below 50 vol %, in order to ensure high hardness for the composite material and hence for the bearing element. Nevertheless, the volume fraction of the hard substance phase may in exceptional cases also be below 50 vol %, or as an exception the fraction of the metallic binder phase may also be above 50 vol %.

The hardness of the bearing element, at least in the region of its surface or boundary layer, or in near-surface or near-boundary-layer regions, is situated in particular between from 1000-2000 HV (Vickers hardness), typically above 1100 HV. The surface or boundary layer of the bearing element may have a particular microstructure region, which differs from deeper-lying microstructure regions in terms of its properties, i.e., in particular, the hardness, and can therefore be delimited from deeper-lying microstructure regions. Surface regions or boundary layer regions of this kind typically are sliding faces or rolling faces provided on the bearing element side—i.e., more particularly, raceway surfaces for sliding or rolling bodies, or corresponding sliding or rolling body faces. The bearing element may of course also have a consistent hardness overall. In exceptional cases, the hardness of the bearing element, even possibly only sectionally, may be below 1000 HV and/or above 2000 HV.

Important for the profile of properties of the composite material, in addition to the chemical and proportional composition, i.e., the volume fraction of the metallic binder phase and of the hard substance phase, are, in particular, the shape, size, and distribution of the hard substance phase grains, forming the hard substance phase, in the metallic binder phase, which serves as the matrix. The hard substance phase grains may generally be from coarse to fine. The hard substance phase grains are preferably round or rotund in morphology. With regard to the production of the composite material, the distribution of the hard substance phase grains forming the hard substance phase in the metallic binder phase serving as the matrix ought as far as possible to be coherent.

One characteristic of the shape, size, and distribution of the hard substance phase grains forming the hard substance phase is the surface quality and therefore the roughness of the bearing element in a ready-machine state, i.e., after machine finishing. A fundamental rule in connection with the roughness of such bearing elements is that, from a techno-economic standpoint, larger external diameters of the bearing elements exhibit higher roughness values in the bearing elements. Roughness investigations show that for bearing elements having external diameters of more than about 200 mm, average roughness values Rₐ in the range of 0.1-1.0 μm can be realized, and, for bearing elements having external diameters of below about 200 mm, average roughness values Rₐ in the range of 0.02-0.2 μm can be realized, attributable to a coherent and homogeneous microstructure, i.e., to a particularly coherent and homogeneous distribution of the hard substance phase grains in the metallic binder phase, particularly in combination with an appropriate fabrication technology.

The bearing element of the invention may for example be a bearing ring, i.e., an outer ring or an inner ring, of a plain or antifriction bearing. The bearing element may also be a sliding or rolling body or a rolling body cage for the accommodation of rolling bodies.

The invention further relates to a bearing, i.e., a plain or antifriction bearing, which comprises at least one bearing element of the invention as described above. The bearing element or elements may as mentioned more particularly be bearing rings and/or sliding or rolling bodies and/or a rolling body cage for accommodating rolling bodies. The bearing of the invention is subject to all of the details given concerning the bearing element of the invention, analogously.

### BRIEF DESCRIPTION OF THE DRAWINGS

An exemplary embodiment of the invention is shown in the drawing and is described in more detail below. In the drawing:

FIG. 1 shows a schematic representation of an antifriction bearing comprising a bearing element according to one exemplary embodiment of the invention;

FIG. 2 shows a segment from a microstructure of a powder-metallurgical composite material for forming a bearing element according to one exemplary embodiment of the invention; and

FIG. 3 shows a diagram for illustrating the corrosion resistance of a bearing element of the invention in comparison to a bearing element formed from a conventional corrosion-resistant antifriction bearing steel.

### DETAILED DESCRIPTION

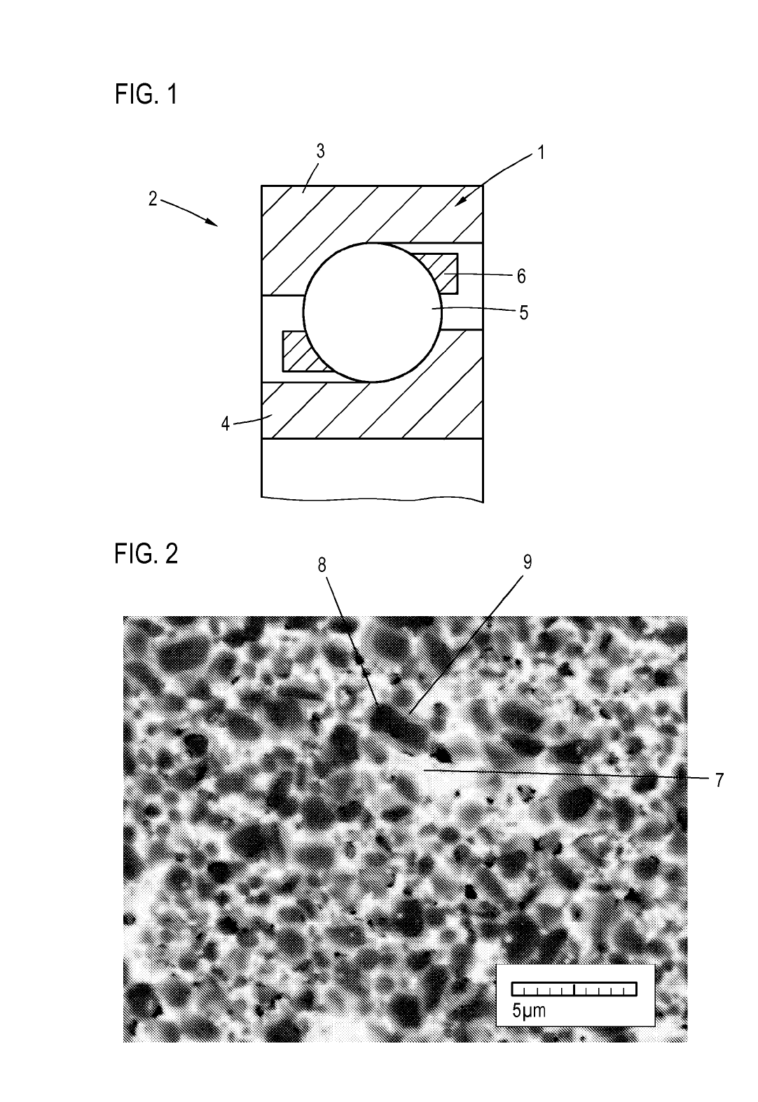

FIG. 1 shows a schematic representation of a bearing element 1 according to one exemplary embodiment of the invention. The bearing element 1 is part of an antifriction bearing 2. The bearing element 1 is the outer ring 3 of the antifriction bearing 2. The inner ring 4 of the antifriction bearing 2 could equally be formed as a corresponding bearing element 1 in accordance with one exemplary embodiment of the invention. The same is true of the rolling bodies 5 which roll between the outer ring 3 and the inner ring 4, and also of the rolling body cage 6 which guides and/or accommodates the rolling bodies 5.

The bearing element 1 could also constitute corresponding components of a plain bearing.

The bearing element 1 is formed from a powder-metallurgical composite material, this being a composite material produced by powder-metallurgical means. The powder-metallurgical composite material comprises a metallic binder phase, and a hard substance phase, which is formed of at least one hard substance. The powder-metallurgical composite material may accordingly also be thought of and termed as a “Metal Matrix Composite”.

The metallic binder phase is based in general on at least one element from the following group: chromium, cobalt, molybdenum, nickel, titanium. This means that the metallic binder phase is formed of at least one element from the following group: chromium, cobalt, molybdenum, nickel, titanium, or comprises as principal constituent at least one element from the following group: chromium, cobalt, molybdenum, nickel, titanium. This also means that the metallic binder phase is formed of or comprises a metallic compound containing chromium and/or cobalt and/or molybdenum and/or nickel and/or titanium. The stated elements may therefore be present in elemental form or in (chemically) bonded form.

The metallic binder phase may further comprise fractions of iron and/or carbon and/or nitrogen and/or of at least one iron and/or carbon and/or nitrogen containing compound. Contemplated in particular as carbon containing compound are chromium carbide and/or molybdenum carbide and/or titanium carbide.

The hard substance phase is generally formed of at least one of the following hard substance compounds, or comprises at least one of the following hard substance compounds: borides, carbides, more particularly titanium carbide and/or tungsten carbide, carbonitrides, more particularly titanium carbonitride, nitrides, more particularly titanium nitride, silicides. The hard substance phase is present typically in the form of individual or a plurality of connected hard substance phase grains. The hard substance phase grains typically have a grain size of approximately 0.5-10 μm, more particularly 0.9-6 μm.

The microstructure of the composite material therefore consists in particular of individual or a plurality of interconnected hard substance phase grains which are surrounded by the metallic binding phase. Accordingly, the metallic binding phase extends between the hard substance phase grains and binds them in the microstructure. The microstructure of the composite material may be compared to a wall structure comprising a plurality of bricks connected by a mortar, with the hard substance phase grains representing the bricks, and the metallic binder phase the mortar.

The hard substance phase in the composite material has a fraction of 50-99 vol %, more particularly a fraction of between 85 and 95 vol %. The metallic binder phase has a fraction of 1-50 vol %, more particularly a fraction of between 15 and 5 vol %.

In one specific exemplary embodiment, the composite material may comprise, as metallic binder phase, nickel and bonded chromium. In this specific exemplary embodiment, the hard substance phase consists of tungsten carbide. The fraction of the hard substance phase is between 85 and 95 vol %. The high fraction of the hard substance phase ensures very high hardness, typically 1150-1750 HV1, on the part of the composite material and therefore on the part of the bearing element 1. The toughness of the metallic binder phase compensates the brittleness of the hard substance phase and ensures good impact strength, typically K_{1c} 7-19 MN/mm^{3/2}, on the part of the composite material and hence on the part of the bearing element 1. The compressive strength of the composite material and hence of the bearing element 1 is between 3500 and 6300 MPa, the modulus of elasticity is in a range between 500 and 650 GPa, the Poisson number is between 0.21 and 0.22, and the density is in a range of between 13.0 and 15.0 g/cm³. The grain size of the hard substance phase grains is between 0.5 and 5 μm.

Similar properties can also be achieved in a further specific exemplary embodiment of the composite material which differs from the above specific exemplary embodiment essentially in that the metallic binder phase consists of cobalt as principal constituent.

In another specific working example of the composite material, this material may comprise, as metallic binder phase, primarily nickel and cobalt. The metallic binder phase here further comprises carbon compounds and/or carbide compounds, such as, in particular, nickel carbide or cobalt carbide compounds. The hard substance phase here is formed of titanium carbide and/or titanium carbonitride. In the composite material here, there is an intermediate phase formed around the hard substance phase grains, this intermediate phase realizing a strong attachment of the hard substance phase grains to the metallic binder phase. The intermediate phase is what is called a κ phase, i.e., a complex carbide structure. The hardness of the composite material and hence of the bearing element 1 is between 1100 and 1650 HV, the impact strength is about K_{1c} 8-14 MN/mm^{3/2}, the modulus of elasticity is between 370 and 450 GPa, the density is between 5.8 and 6.9 g/cm³. It should be emphasized that the comparatively low density of the composite material results in a comparatively low component weight.

FIG. 2 shows a detail of a microstructure of a powder-metallurgical composite material, similar to the exemplary embodiment described above, for forming a bearing element 1 according to one exemplary embodiment of the invention. The metallic binder phase, which here comprises primarily nickel and molybdenum, is indicated by reference 7; the hard substance phase grains, which here consist of titanium carbonitride, are indicated by reference symbol 8; and the κ phase is indicated by reference symbol 9. The attachment of the hard substance phase grains 8 to the metallic binder phase 7 is accomplished via the intermediate phase 9 which immediately surrounds the hard substance phase grains 8.

With all of the exemplary embodiments of the composite material it is possible, depending on external diameter, to realize bearing elements 1 having average roughness values Rₐ of between 0.02 and 1.0 μm, which signifies coherent and homogeneous distribution of the hard substance phase grains in the metallic binder phase and also high surface quality on the part of the bearing elements 1, as a result in particular of the selection of appropriate fabrication parameters.

Viewed overall, the composite material forming the bearing element 1, and hence the bearing element 1 as well, are notable for high strength, high toughness, high hardness, high overrolling resistance and wear resistance, high thermal conductivity, and high corrosion resistance.

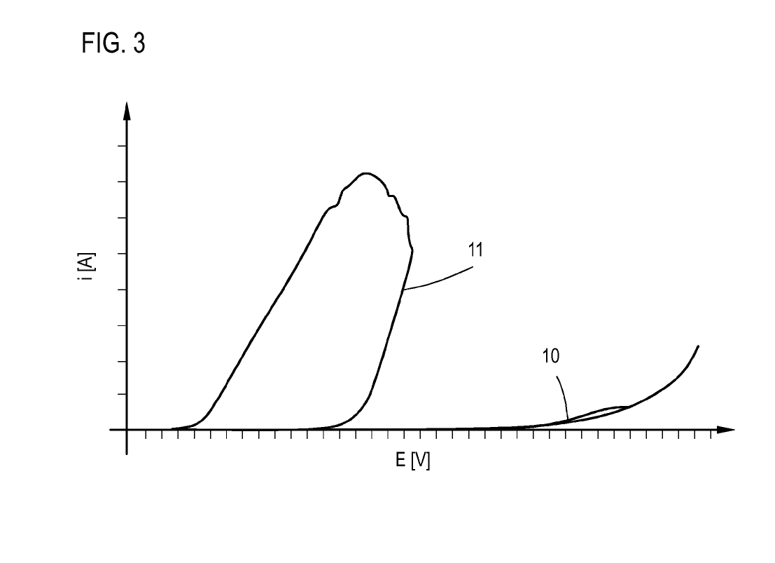

FIG. 3 shows a diagram for illustrating the corrosion resistance of a bearing element 1 of the invention in comparison to a bearing element formed from a conventional corrosion-resistant antifriction bearing steel. From FIG. 3 it is possible to illustrate the improved corrosion resistance of the composite material forming the bearing element 1 of the invention, in comparison to one comprising a conventional antifriction bearing steel.

The diagram shown in FIG. 3 plots the electrical current (y-axis) against the electrical potential (x-axis). The diagram shows experimental results from electrochemical investigations of the pitting potential or repassivation potential (Ag/AgCl, 3.5% NaCl, 20° C.). The curve 10 represents the results of measurement for a bearing element 1 of the invention; the curve 11 represents the results of measurement for a noninventive bearing element formed of a conventional antifriction bearing steel.

As can be seen, the breakdown of material, indicated by the rise in the curve 10, begins significantly later for the bearing element 1 of the invention than for the noninventive bearing element. The repassivation potential, i.e., the potential at which the curves meet the x-axis again after having risen, is much higher for the bearing element 1 of the invention, in comparison to the noninventive bearing element. The investigations demonstrate the very good corrosion resistance of the bearing element 1 of the invention.

### LIST OF REFERENCE NUMERALS

1 Bearing element
2 Antifriction bearing
3 Outer ring
4 Inner ring
5 Rolling body
6 Rolling body cage
7 Metallic binder phase containing nickel and molybdenum
8 Hard substance phase grains
9 κ phase
10 Curve
11 Curve

1-10. (canceled)

11. A bearing element for a plain or antifriction bearing, the bearing element comprising:
at least sectionally a powder-metallurgical composite material including a metallic binder phase and a hard material phase, wherein the metallic binder phase is based on at least one element from the group consisting of chromium, cobalt, molybdenum, nickel, and titanium.

12. The bearing element as recited in claim 11 wherein the metallic binder phase further comprises fractions of iron or carbon or nitrogen or of at least one iron or carbon or nitrogen containing compound.

13. The bearing element as recited in claim 12 wherein the metallic binder phase comprises chromium carbide or molybdenum carbide or titanium carbide as carbon containing compound.

14. The bearing element as recited in claim 11 wherein the hard material phase includes individual hard material phase grains, and the composite material includes an intermediate phase formed around the hard material phase grains, attachment of the hard material phase grains to the metallic binder phase is realized via the intermediate phase.

15. The bearing element as recited in claim 11 wherein the hard material phase is includes at least one of the following hard material compounds: borides, carbides, carbonitrides, and silicides.

16. The bearing element as recited in claim 15 wherein the hard material phase includes titanium carbide or tungsten carbide.

17. The bearing element as recited in claim 15 wherein the hard material phase includes titanium carbonitride or titanium nitride.

18. The bearing element as recited in claim 11 wherein the hard material phase in the composite material has a fraction of 50-99 vol % and the metallic binder phase has a fraction of 1-50 vol %.

19. The bearing element as recited in claim 18 wherein the hard material phase in the composite material has a fraction of between 85 and 95 vol %, and the metallic binder phase has fraction of between 5 and 15 vol %.

20. The bearing element as recited in claim 11 wherein, at least in the region of the surface, the bearing element has a hardness of 1000-2000 HV.

21. The bearing element as recited in claim 11 wherein, at least in the region of the surface, the bearing element has a hardness above 1100 HV.

22. The bearing element as recited in claim 11 wherein the bearing element has an average roughness value Rₐ of between 0.02 and 1.0 μm.

23. The bearing element as recited in claim 11 wherein the bearing element is a bearing ring or a sliding or rolling body or a rolling body cage for accommodating rolling bodies.

24. A bearing comprising the bearing element as recited in claim 11.

25. A plain or antifriction bearing comprising the bearing as recited in claim 24.
